(19) United States
(12) Patent Application Publication
(10) Pub. No.: US 2012/0198841 A1
(43) Pub. Date: Aug. 9, 2012

(54) LIQUID-COOLED EXHAUST MANIFOLD

(75) Inventor: Clayton A. Sloss, Paris (CA)

(73) Assignee: WESCAST INDUSTRIES, INC., Brantford, ON (CA)

(21) Appl. No.: 13/394,174

(22) PCT Filed: Oct. 13, 2010
(86) PCT No.: PCT/IB2010/002615

§ 371 Date: Mar. 5, 2012

Related U.S. Application Data
(60) Provisional application No. 61/251,427, filed on Oct. 14, 2009.
(60) Provisional application No. 61/348,481, filed on May 26, 2010.

(51) Int. Cl. F01N 3/04; B23P 17/00; F01P 3/12; F01N 13/10; F02B 33/44

(52) U.S. Cl. 60/605.1; 60/320; 60/321; 60/274; 29/527.5

(57) ABSTRACT

A component of an exhaust system may convey exhaust gas between one or more inlets and one or more outlets and may include at least one fluid path in thermal communication with the exhaust gas. The fluid path may be defined by an external surface of the component and a cover plate attached to the external surface. The fluid path may be connected to a coolant source.

### CROSS-REFERENCE TO RELATED APPLICATIONS

This application claims the benefit of U.S. Provisional Application No. 61/251,427, filed on Oct. 14, 2009, and U.S. Provisional Application No. 61/348,481, filed on May 26, 2010. The entire disclosures of each of the above applications are incorporated herein by reference.

### FIELD

The present disclosure relates to exhaust components with fluid passages to regulate the material temperature of the exhaust component and/or to extract energy from the exhaust stream.

### BACKGROUND

This section provides background information related to the present disclosure and is not necessarily prior art.

Automobile manufacturers and the entire transportation sector are facing an increasingly stringent set of regulations for fuel efficiency and emissions. Also, there is pressure from vehicle operators to improve fuel efficiency to reduce operating costs. To meet these objectives, automakers are adopting new technologies such as turbocharged gasoline direct-injection engines and lean burn combustion which tend to raise exhaust gases to higher temperatures.

Most conventional internal combustion engines have maximum time averaged exhaust gas temperatures near or below 900° C. For these applications, low cost cast iron alloys such as silicon-molybdenum (SiMo) cast iron are often sufficient to meet the durability requirements for use in exhaust components. For applications with durability issues or slightly higher exhaust gas temperatures, nickel cast iron alloys such as D5S Ni-Resist (˜35% Ni) are often specified for cast components, but at increased cost. Many new engines, especially turbocharged gasoline direct-injection engines, can achieve exhaust gas temperatures above 950° C. It is current practice in the automotive industry to use wrought stainless steel or cast stainless steel for the most demanding applications. These can be the most expensive types of components to manufacture.

The present disclosure is a method of solving the problem posed by the need to use more expensive materials for exhaust components when low cost materials will not meet the durability requirements for that application. In order to achieve the desired durability with the low cost materials, the temperature of the component in service may be regulated and kept below a threshold limit for the particular material for that application. Often the threshold limit is below the Ac1 transformation temperature for a particular material, and may be well below the transformation temperature for cases with high operating stresses or strains. Water cooling of exhaust components is one method of regulating the exhaust component material temperature.

A water jacket may be produced by using a foam pattern that evaporates during the casting process to form the desired geometry for the exhaust manifold and surrounding water jacket. Another process to create a water jacket in a cast exhaust manifold is to use a water jacket core during manufacturing. In this case, the entire water jacket is created by one or more internal sand cores assembled in the mould prior to casting.

### SUMMARY

This section provides a general summary of the disclosure, and is not a comprehensive disclosure of its full scope or all of its features.

The present disclosure provides an exhaust component having a method of creating a cavity on an exterior surface thereof and a method of forming the cavity in a low cost, robust manner for the purposes of heat exchange between exhaust gases and a heat transfer medium such as engine coolant. While the following examples and discussion generally relate to cooling of exhaust manifolds, it should be understood that the general concepts discussed herein are also applicable to other exhaust components and/or systems such as turbocharger housings and exhaust gas heat recovery systems, by way of non-limiting examples.

The present disclosure relates to a fluid cooling cavity for an exhaust component without using a traditional internal water jacket core during the casting process. By the terms “fluid” or “coolant”, it is meant any of a various number of liquids or gases suitable to carry out one or more objectives of the present disclosure. For example, the fluid or coolant could be water, refrigerant, engine coolant or any other suitable fluid. The present disclosure illustrates a method of creating a partial cavity on the exterior of the exhaust component, usually without any additional external cores. The partial cavity is then closed by welding or brazing a separate piece to the exhaust component after the casting process is complete to create the fluid jacket, i.e., water jacket.

A fluid cooled exhaust component is desired for purposes of durability and/or heat extraction. In the case of cooling the component for durability reasons, a lower cost material may be employed in the construction of the exhaust component than would be otherwise possible. The fluid cooled exhaust manifold of the current disclosure is formed by creating a fluid cooling cavity on the surface of the manifold through a combination of casting features and welded plate(s). The welded plate may or may not have additional geometrical features to modify the flow of coolant fluid. The external casting geometry is manipulated to form part of the jacket cavity and provide an appropriate interface for the plate(s) to be welded on. The preferred embodiment is to create the casting interface geometry such that the weld-on plate(s) are flat, however the plate(s) could also be shaped to follow a curved interface on the cast component or be shaped to form part of the cavity walls. In some embodiments, one cover plate may correspond to each cavity formed by the cope or drag tooling. For example, in the configuration shown in FIGS. 1 and 2, two cover plates are provided because fluid cooling cavities are formed on both sides of the part (on either side of the parting line). This may be clarified by referring to FIGS. 3 and 4 which show cavities formed on both sides of the parting line PL, and separate cover plates 4 and 8 for each of these cavities. Whereas multiple cover plates may be provided for the embodiment shown in FIGS. 1 and 2, if it is desired to only cool one portion of the exhaust component formed by one part of the tooling, then it may be advantageous to employ a single cover plate such as with the embodiment illustrated in FIG. 7.

The casting interface geometry is ideally created solely by the mould pattern during the moulding and casting process. When possible to do this, no extra cores are required and the mould pattern generates the interface geometry to avoid the cost of producing and using an external core to form part of the water jacket cavity. Additionally, the cooling cavity of the present disclosure avoids a major issue of creating the water jacket by means of an internal casting core. With an internal casting core, the core sand is removed from blind passageways after casting. The internal cavities created by an internal casting core are very difficult to clean out or even inspect. Cleanliness of passages is paramount for the vehicle's cooling system reliability. The cooling cavity of the present disclosure is open after casting for easy cleaning and inspection prior to welding of the plate(s). In the fluid cooled exhaust manifold of FIG. 1, the cooling cavity is formed with one coolant inlet, one coolant outlet, two weld plates, and the exterior surface of the cast manifold. An alternative embodiment is to have one coolant inlet and one coolant outlet for each weld plate. In that case each weld plate would be associated with an independent fluid cooling cavity. The number of independent cooling cavities may depend on the objectives for heat transfer of the application.

In designing the size, shape, and location of the cooling cavity, many variables may be considered. For example, the temperature limits of the cast material and/or the amount of energy absorbed by the coolant fluid are key considerations. Excess thermal energy in the coolant water may need to be rejected by the vehicle's cooling system. Packaging constraints also place limitations on where the fluid jacket can be located and constrains locations for coolant connections in and out of the cooling cavity.

In the case of fluid cooling the exhaust component for durability purposes, it may be desirable to only place the cooling cavity in areas that need to be cooled to improve durability. For example, in the fluid cooled exhaust manifold of FIG. 1, it can be seen that the water cooling cavity is only located near the outlet of the exhaust manifold. This outlet region is the hottest part of the component as the exhaust gases from all of the engine's cylinders are joined together at this location. In addition to being the hottest region, the area near the outlet is also of the greatest concern for durability in a typical non-cooled exhaust manifold. However, with fluid cooling, a cast iron exhaust manifold in this geometry can survive operating conditions that would require heat resistant stainless steel in the absence of cooling. For the fluid cooled component shown in FIGS. 1 and 2, cooling cavities and corresponding cover plates are disposed on both sides of the manifold outlet.

Additional opportunities for a low cost, robust fluid-cooled exhaust component exist for applications such as thermoelectric waste energy recovery systems and active warm up (AWU) systems. Electricity generated from thermoelectric devices that convert waste exhaust energy directly into electricity can be used to charge a battery or offset electrical loads in a vehicle. AWU systems utilize waste thermal energy from the exhaust system and use it to warm up other vehicle fluid systems (engine coolant, engine oil, and transmission and transaxle fluids). The thermal regulation of these fluid systems can reduce viscous losses during start up, resulting in improved fuel efficiency and improved cabin warm-up.

If the goal of fluid cooling the exhaust manifold is to recover as much waste exhaust gas heat as possible, the cooling cavity(ies) would be designed to incorporate as much of the exhaust manifold as was practical and cost effective.

To achieve the greatest cost reduction, the preferred material for the fluid cooled cast exhaust manifold is an alloy of cast iron, such as low cost silicon-alloyed nodular cast iron. The preferred material for the weld-on plate(s) is ferritic stainless steel. This material combination is one of the lowest cost options, and is mentioned as a non-limiting example of materials for construction.

In one form, the present disclosure provides an exhaust system that may include an exhaust component, a plate, at least one inlet and at least one outlet. The exhaust component may include at least one exhaust gas passageway and may partially define at least one fluid cavity. The plate may be attached to the exhaust component and at least partially enclose the at least one fluid cavity to define at least one fluid passageway. The at least one fluid passageway may be fluidly isolated from the at least one exhaust gas passageway. A fluid may enter the fluid passageway through the at least one inlet. The fluid may flow exit the fluid passageway through the at least one outlet.

In another form, the present disclosure provides an exhaust system for a vehicle that may include an exhaust component and a plate. The exhaust component may include an integrally formed exhaust gas passageway and an integrally formed fluid cavity. The plate may be attached to the exhaust component and at least partially enclose the fluid cavity to define a fluid conduit. The fluid conduit may be fluidly isolated from the exhaust gas passageway. The plate may include an integrally formed inlet and an integrally formed outlet. The inlet and outlet may be in fluid communication with the fluid conduit.

In yet another form, the present disclosure provides a method that may include casting an exhaust component to include an exhaust gas passageway having an external surface defining a fluid cavity. A plate may be provided that may include a first port and a second port. The plate may be attached to the exhaust component such that the plate and the fluid cavity cooperate to form a fluid conduit in fluid communication with the first port and the second port.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 shows an exterior perspective view of an assembled fluid cooled exhaust manifold in accordance with the teachings of the present disclosure;

FIG. 2 shows a break-away section of a fluid cooled exhaust manifold;

FIG. 3 illustrates cross-section AA of the fluid cooled manifold of FIG. 1;

FIG. 4 illustrates cross-section BB of the fluid cooled manifold of FIG. 1;

FIG. 5 shows a cross-section of a fluid cooled cast exhaust component assembly designed for use with a thermoelectric device, manufactured without the use of external cores;

FIG. 6 shows a cross-section of a fluid cooled cast exhaust component assembly designed for use with a thermoelectric device, manufactured with the use of an external core to be able to place a thermoelectric device on a surface perpendicular to the parting plane;

FIG. 7 depicts another embodiment of a fluid-cooled cast exhaust manifold assembly designed specifically for heat extraction for active warm up purposes;

FIG. 8 is the manifold of FIG. 7 with the weld plate removed to show the fluid passages;

FIG. 9 is the manifold assembly of FIG. 7 in section to illustrate the interaction of the cover plate and the casting to form the profiled fluid passage;

FIG. 10 shows structured features for enhancing the heat transfer from the exhaust gases to the coolant by altering the gas passage geometry;

FIG. 11 is a perspective view of another exhaust component having a cover plate according to the principles of the present disclosure;

FIG. 12 is a perspective view of the exhaust component of FIG. 11 with the cover plate removed;

FIG. 13 is another perspective view of the exhaust component of FIG. 11;

FIG. 14 is a perspective view of another exhaust component having a cover plate according to the principles of the present disclosure;

FIG. 15 is a perspective view of the exhaust component of FIG. 14 with the cover plate removed;

FIG. 16 is a perspective view of another exhaust component according to the principles of the present disclosure;

FIG. 17 is a perspective view of yet another exhaust component according to the principles of the present disclosure;

FIG. 18 is a partially cross-sectioned perspective view of the exhaust component of FIG. 17;

FIG. 19 is a perspective view of yet another exhaust component having a cover plate according to the principles of the present disclosure;

FIG. 20 is a perspective view of the exhaust component of FIG. 19 with the cover plate removed to illustrate a fluid flow path therethrough;

FIG. 21 is a partially cross-sectioned perspective view of yet another exhaust component having a cover plate according to the principles of the present disclosure;

FIG. 22 is a perspective view of yet another exhaust component having a partially cutaway cover plate to illustrate a fluid flow path according to the principles of the present disclosure;

FIG. 23 is a perspective view of yet another exhaust component having a partially cutaway cover plate to illustrate a fluid flow path according to the principles of the present disclosure;

FIG. 24 is cross-sectional view of the exhaust component of FIG. 23; and

FIG. 25 is a perspective view of yet another exhaust component having a partially cutaway cover plate to illustrate a fluid flow path according to the principles of the present disclosure.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

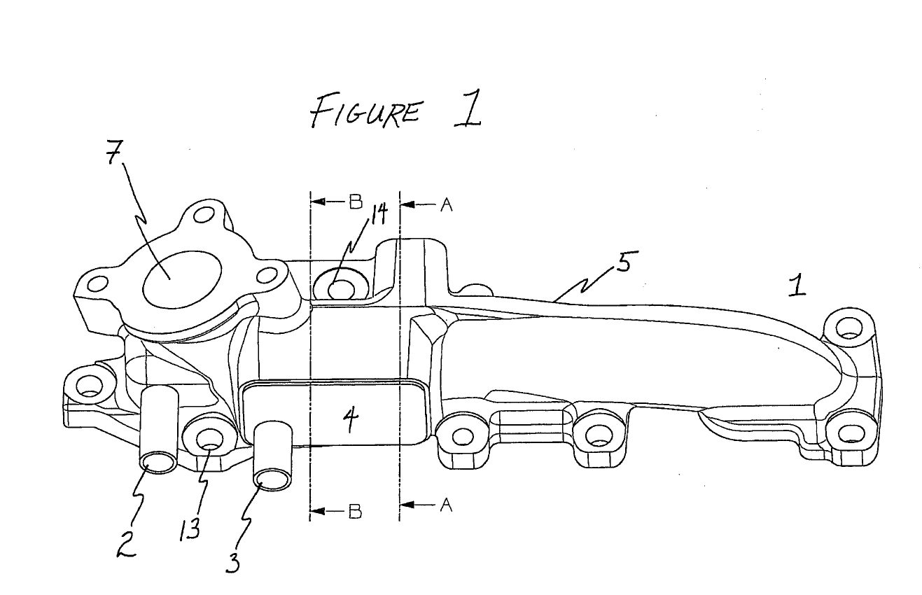

With reference to FIG. 1, a fluid cooled exhaust manifold assembly 1 is provided that may include a coolant inlet 2 and coolant outlet 3. In this embodiment, the coolant outlet 3 is welded to the plate 4 and the coolant inlet 2 is attached directly to the cast exhaust manifold 5. The periphery of plate 4 is welded to the cast exhaust manifold 5 along the interface 6. The interface 6 is formed on the exterior of the cast fluid cooled exhaust manifold 1, preferably by the pattern tooling in the moulding process prior to casting. This external casting geometry forms part of the cooling cavity wall and terminates at the interface 6 for attaching the plate 4. The cooling cavity that is formed allows the water or coolant to extract energy from the exhaust gases and/or regulate the material temperatures of the cast manifold 5 in the region of the manifold outlet 7.

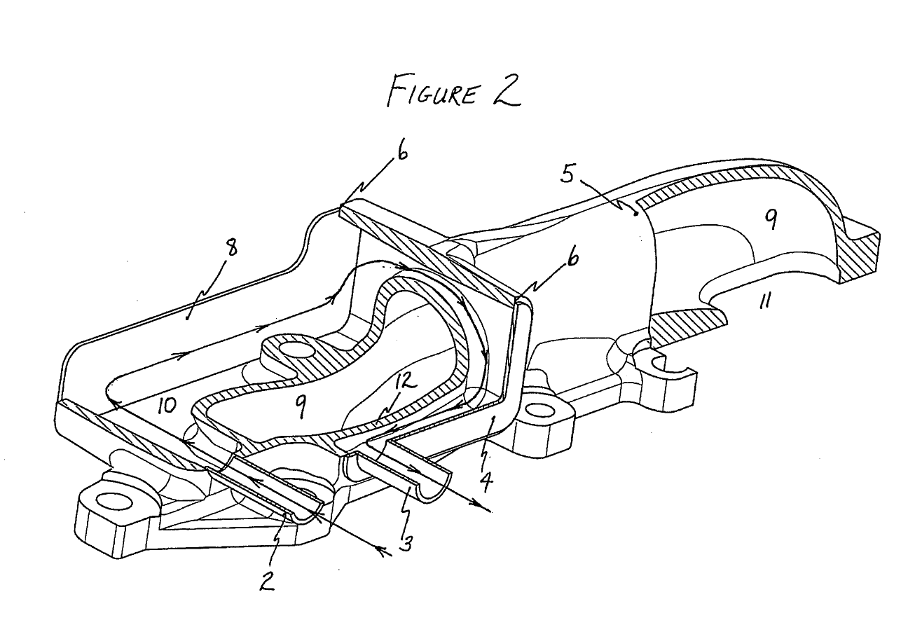

FIG. 2 illustrates the flow path of the cooling medium and the exhaust gases. The internal cavity 9 formed by the walls of the cast exhaust manifold 5 is used to convey the engine's exhaust gases as they travel from the inlets 11 of the exhaust manifold 5 to the exhaust system. The exterior of the cast manifold walls 5, along with the cast interface geometry 6 and the plates 4 and 8 together form interconnected cavities 10 within which the coolant flows. Two cover plates may be provided, as cooling cavities are provided on separate sides of the parts as determined by the layout and parting plane of the casting tooling. The cast wall 12 of the exhaust manifold is used to separate the flow of exhaust gases in the interior of the manifold 9 from the cooling fluid in the cavity 10 superimposed upon the exterior of the cast manifold 5. Thermal exchange occurs through the cast manifold wall 12 between the hot exhaust gases and the cooling fluid.

In the embodiment shown in FIGS. 1 and 2, when the fluid cooled exhaust manifold is installed on an engine, the coolant enters at the coolant inlet 2 near the exhaust gas outlet 7 on the bottom of the manifold and passes through to the cooling cavity on the top side of the manifold. The coolant, a water-glycol solution used in the engine cooling system in this example, then travels through the cooling cavity on the top of the manifold to the bottom of the manifold. The coolant then travels through the cooling cavity formed on the bottom of the manifold and out the coolant outlet 3. The shape and routing of the cooling cavity(ies) will depend on the application. In the cast fluid cooled exhaust manifold 1 shown in FIG. 1, the cooling cavity was located to avoid interference with fastener holes 13 and 14 while keeping the material temperature in the region of the outlet 7 well within the operating temperature range for the cast iron material.

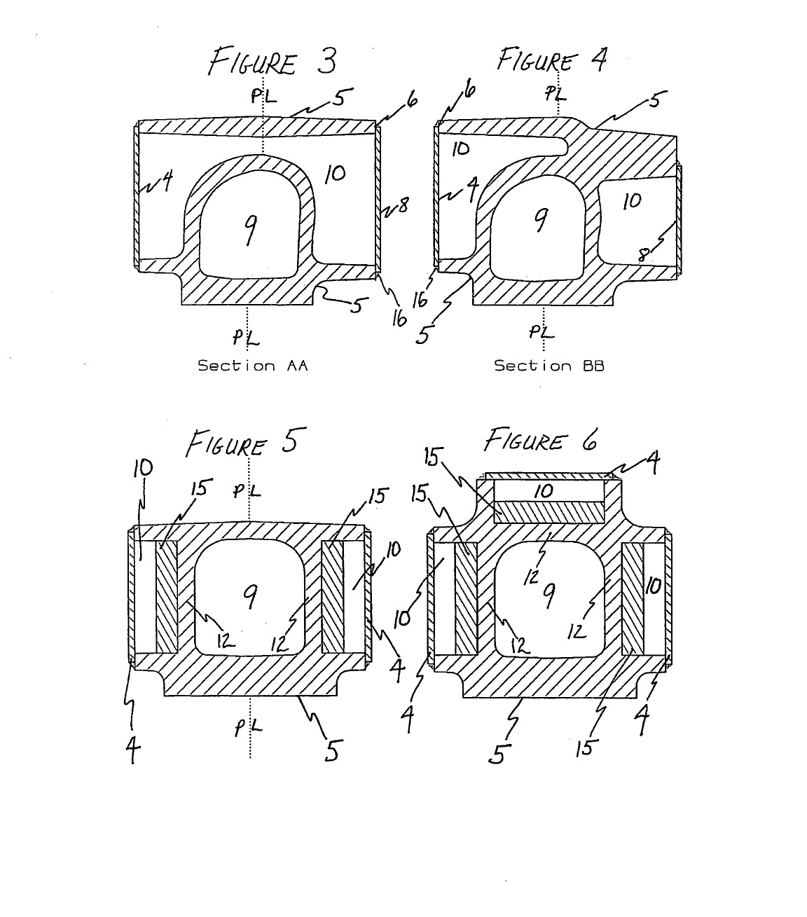

FIGS. 3 and 4 illustrate cross-sectional views AA and BB as defined in FIG. 1. These cross-sectional views clearly illustrate that it is possible to partially cool or entirely surround the internal exhaust gas passageway 9 with one or more cooling cavities 10. Furthermore, it is evident that the fluid jacket cavity geometry can be formed using tooling surfaces drafted to the parting surface PL, hence without the need for external cores in the casting process. The weld 16 joins the plate 4 to the cast exhaust manifold 5.

FIG. 5 is an alternative configuration where the cavity geometry has been modified for use with thermoelectric devices 15. The thermoelectric devices 15 operate by using the temperature difference created between the hot wall 12 of the exhaust manifold and the much lower temperature in the cooling cavity 10. As shown here, two primary surfaces parallel to the parting surface are available for use with the thermoelectric devices. FIG. 6 depicts an embodiment of a fluid-cooled cast exhaust manifold with a thermoelectric device 15 placed on a surface of the internal exhaust gas passageway 9 that is substantially perpendicular to the mould parting surface. In this case the cooling cavity encapsulating the parting line PL is formed by a separate external core during the moulding process prior to casting or by machining the cavity.

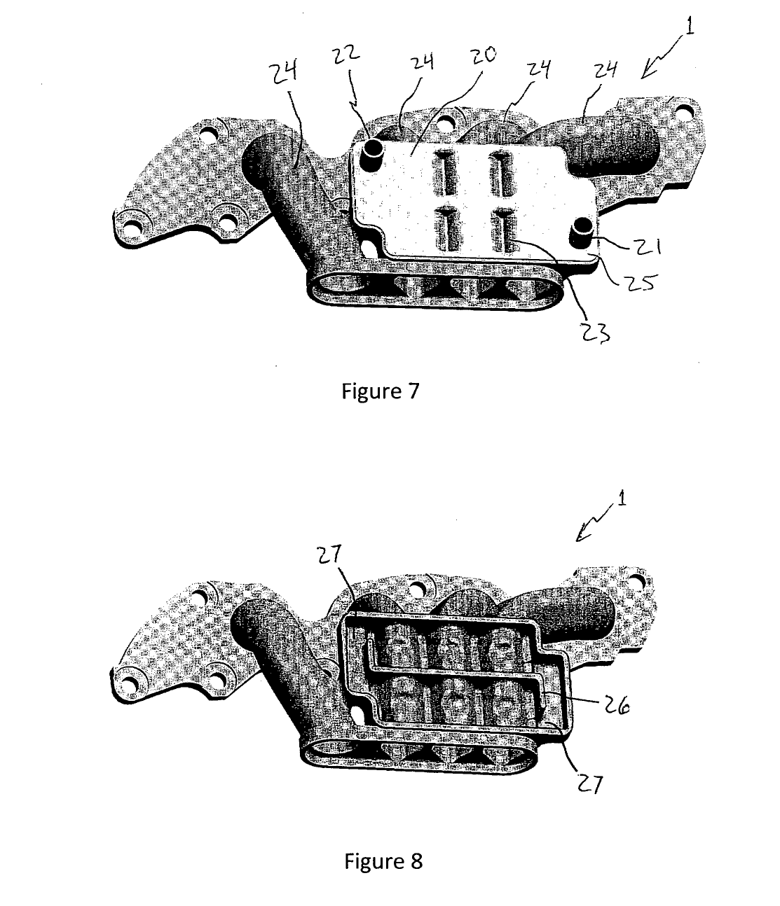

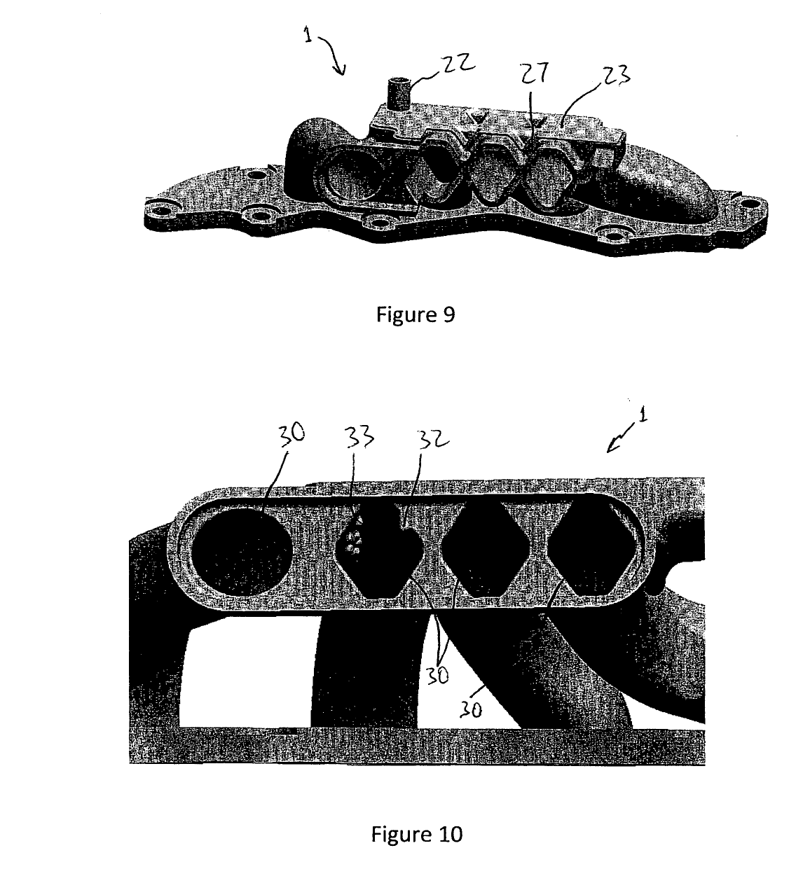

FIG. 7 is another embodiment of a fluid cooled cast exhaust manifold 1 designed to extract thermal energy from the exhaust gases to warm up the engine coolant. A cover plate 20 is welded to the exhaust manifold 1 along the weld interface 25. A coolant inlet 21 and a coolant outlet 22 are provided in the cover plate 20. Alternatively, the coolant inlet and outlet could be formed integrally with the cast manifold if desired. The cover plate 20 has geometric features 23 that help to guide the flow of coolant through the cooling channels. Thermal energy is transferred from the exhaust gases as they pass through the manifold runners 24 to the coolant. An example routing of the coolant channels 27 is shown in FIG. 8. An intermediate wall or rib 26 is formed as part of the casting for the purposes of guiding and distributing the flow of coolant through the coolant channels 27. FIG. 9 illustrates the relationship between the cast manifold 1 and the geometry of the cover plate 23 to form the desired geometry of the cooling channel 27.

FIG. 10 depicts methods of enhancing the heat transfer from the exhaust gases to the coolant by altering the gas passage geometry. The exhaust gas passageway 30 has geometric irregularities such as internal scallops 31, internal fins or ribs 32, and/or internal pins 33 that provide additional surface area to enhance the rate of heat transfer from the exhaust gases to the coolant in the cooling channels.

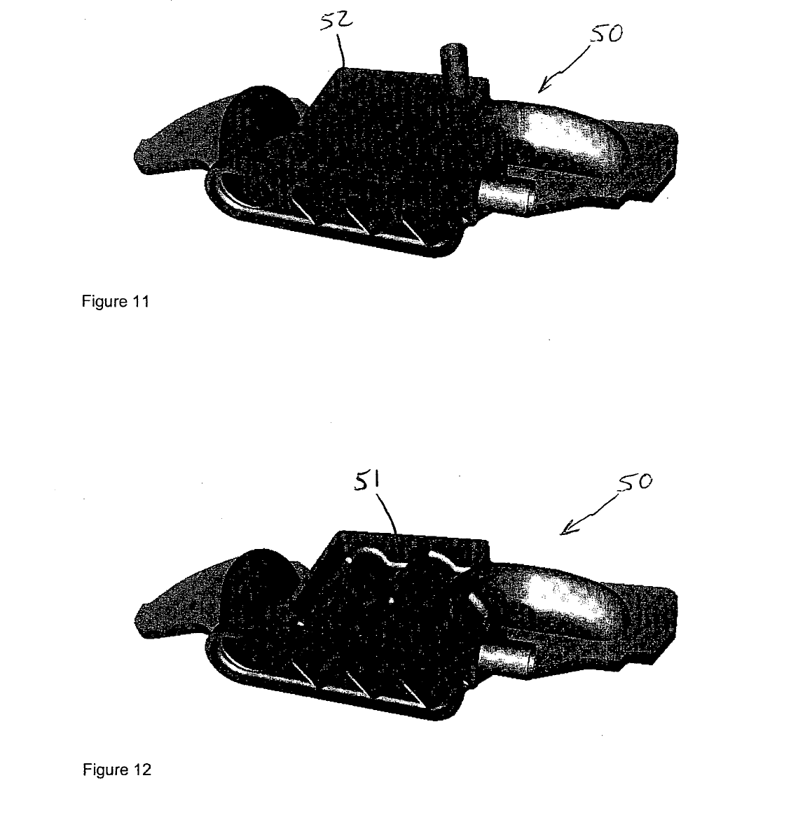

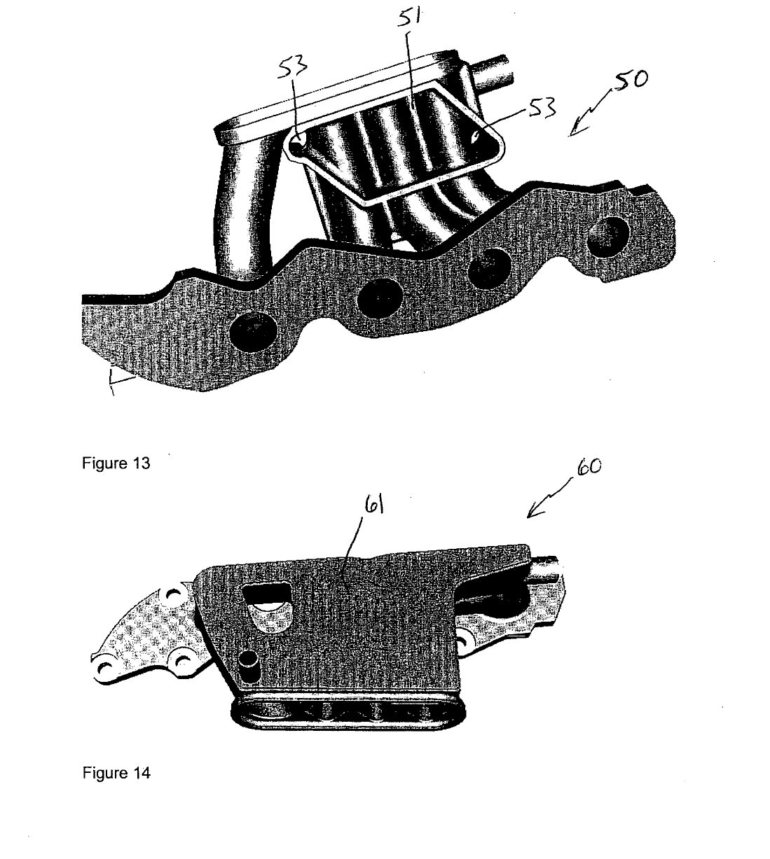

FIGS. 11, 12, and 13 show a fluid cooled exhaust manifold 50 with cooling cavities 51 on two sides of the component. FIG. 11 shows the assembly with the top cover plate 52 in place. FIG. 12 is the same embodiment as FIG. 11 with the top cover plate removed. FIG. 13 is a bottom view of the same embodiment with the bottom cover plate removed. The cooling fluid passes between the cooling cavities by means of passageways 53.

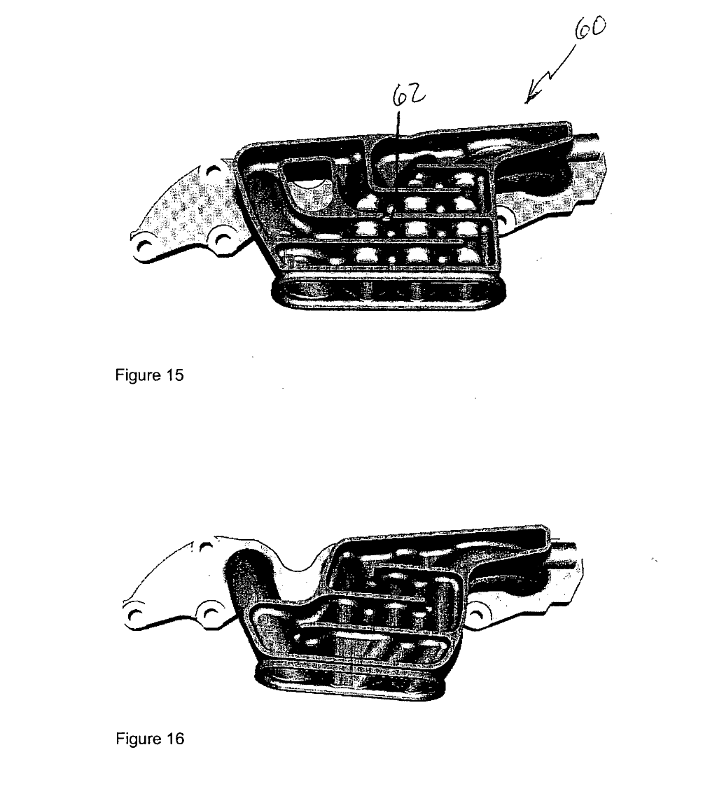

FIG. 14 is an alternative embodiment of the fluid cooled exhaust manifold 60 with only a single coolant cavity on the top side of the component. FIG. 15 is the same embodiment as FIG. 14, only shown with the cover plate 61 removed. Note that a small drain passageway 62 is provided to allow the coolant to completely drain out of the cooling cavity in the event of a cooling system service. This embodiment has the advantage of completely covering all of the hot surfaces of one side of the exhaust component. Therefore, it is possible to eliminate the heat shield that may otherwise be provided to shield nearby components from the heat of the exhaust component 60.

FIG. 16 is another alternative embodiment with a single cooling cavity, shown with the cover plate removed. Note that this configuration of cooling cavity is advantageous for some applications as it has a continuous cooling specifically designed to eliminate trapped gas or liquid in unwanted pockets, particularly when installed vertically.

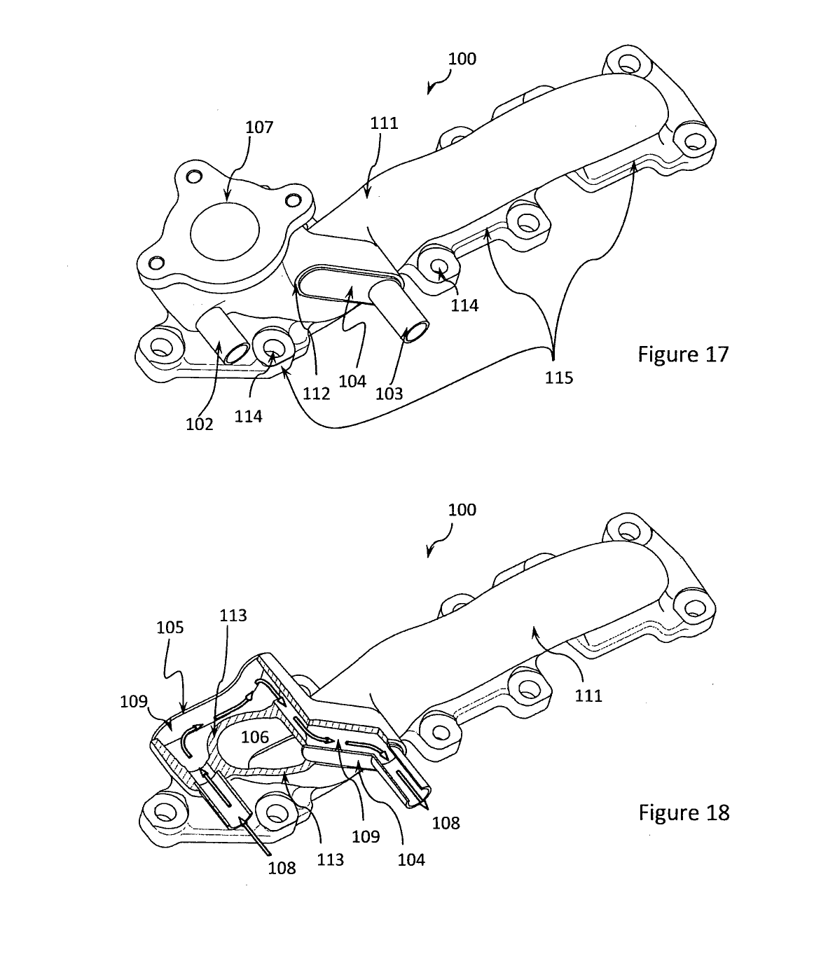

With reference to FIG. 17, a fluid-cooled exhaust manifold assembly 100 is provided and may include a coolant inlet 102 and a coolant outlet 103. In the particular embodiment illustrated in FIG. 18, the coolant outlet 103 is joined to a cover plate 104 and the coolant inlet 102 is attached directly to a cast exhaust manifold 111. The periphery of the cover plate 104 is welded to the cast exhaust manifold 111 along an interface 112. The interface 112 is formed on the exterior of the cast fluid-cooled exhaust manifold 111 and is created by the pattern tooling in a moulding/casting process. This external casting geometry forms part of the cooling cavity wall and terminates at the interface 112 for attaching the cover plate 104. The coolant passageway that is formed allows the coolant to extract energy from the exhaust gases and/or regulate the material temperatures of the cast manifold 111 in the region of interest, in this case the area of highest temperature which occurs near a manifold outlet 107.

FIG. 18 illustrates a flow path 108 of a cooling medium for the same fluid-cooled exhaust manifold assembly of FIG. 17. A coolant passageway 109 is formed by the exterior surface of walls 113 of the cast exhaust manifold 111 and the cover plate 104 and cover plate 105. The interior surface of the cast exhaust manifold walls 113 form a separate exhaust gas passageway 106 that conveys the exhaust gases from an engine as the exhaust gases travel from the inlets of the exhaust manifold to the outlet of the exhaust manifold 107. Two cover plates may be provided, as cooling cavities are disposed on separate sides of the cast component as determined by a layout and parting plane of a particular casting tooling. Thermal exchange occurs through the cast manifold wall 113 between the hot exhaust gases and the coolant.

In the embodiment shown in FIGS. 17 and 18, when the fluid-cooled exhaust manifold is installed on an engine, the coolant enters through the coolant inlet 102 near the exhaust gas outlet 107 and passes through to the coolant passageway 109 of the manifold. The coolant, a water-glycol solution used in the engine cooling system, for example, then travels through the coolant passageway and through the coolant outlet 103. The shape and routing of the cooling passageway(s) may depend on the application. In the cast fluid-cooled exhaust manifold 100 shown in FIG. 17, the cooling cavity may be positioned to avoid interference with fastener holes 114 in the inlet flange 115 while keeping the material temperature in the region of the outlet 107 well within the operating temperature range for the cast iron material. The manufacturing advantages of this arrangement are that no extra cores are required during the casting process to form the cooling cavity walls and the cooling cavities are completely open for cleaning and inspection after casting.

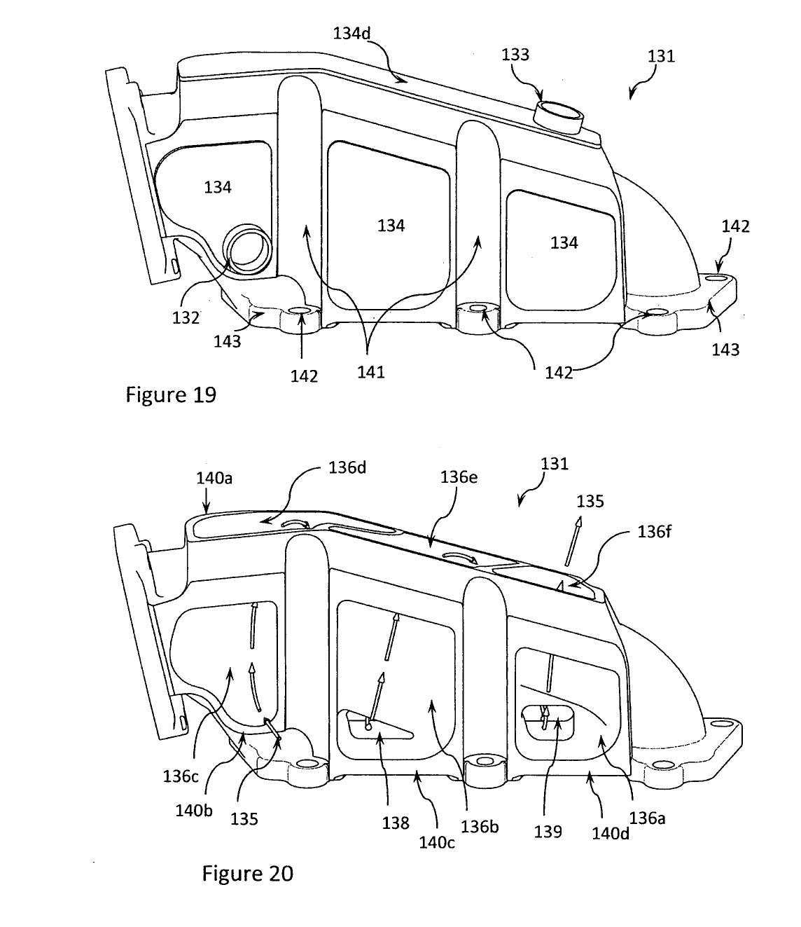

FIGS. 19 and 20 illustrate another embodiment of the fluid-cooled exhaust component. This embodiment illustrates that it is possible to partially cool or entirely surround the exhaust component 131 with cooling cavities 136a-f as required. Furthermore, it is evident that all of this water jacket cavity geometry can be formed using tooling surfaces drafted to the parting surface and external cores without the need for additional internal cores in the casting process. This facilitates cleaning and inspection while avoiding the complexity of locating, cleaning, and inspecting water jackets formed wholly and integrally with the cast exhaust component.

The embodiment shown in FIGS. 19 and 20 may include a series of cavities around the exhaust manifold 131, arranged to provide a generally helical coolant passageway 135 through which the coolant may travel. The coolant enters the exhaust component 131 from the engine cooling system through a coolant inlet 132. From there, the coolant enters cooling cavity 136c, flows to cooling cavity 136d, and travels through a similar adjoining cooling cavity and passes through a connecting orifice 138 into cooling cavity 136b. From there the coolant takes a similar path into cooling cavity 136e and another adjoining cooling cavity returns the coolant to orifice 139 and into cooling cavity 136a. Finally, the coolant passes into cooling cavity 136f and through a coolant outlet 133. The coolant inlet 132 is joined to the cover plate 134c and the coolant outlet is joined to cover plate 134d. Interfaces 140a-140d may be provided for joining the cover plates 134a-134d to the cast exhaust component. Multiple coolant cavities may be provided to avoid engine assembly clearance zones 141. These clearance zones 141 may correspond to the mounting holes 142 in inlet flange 143.

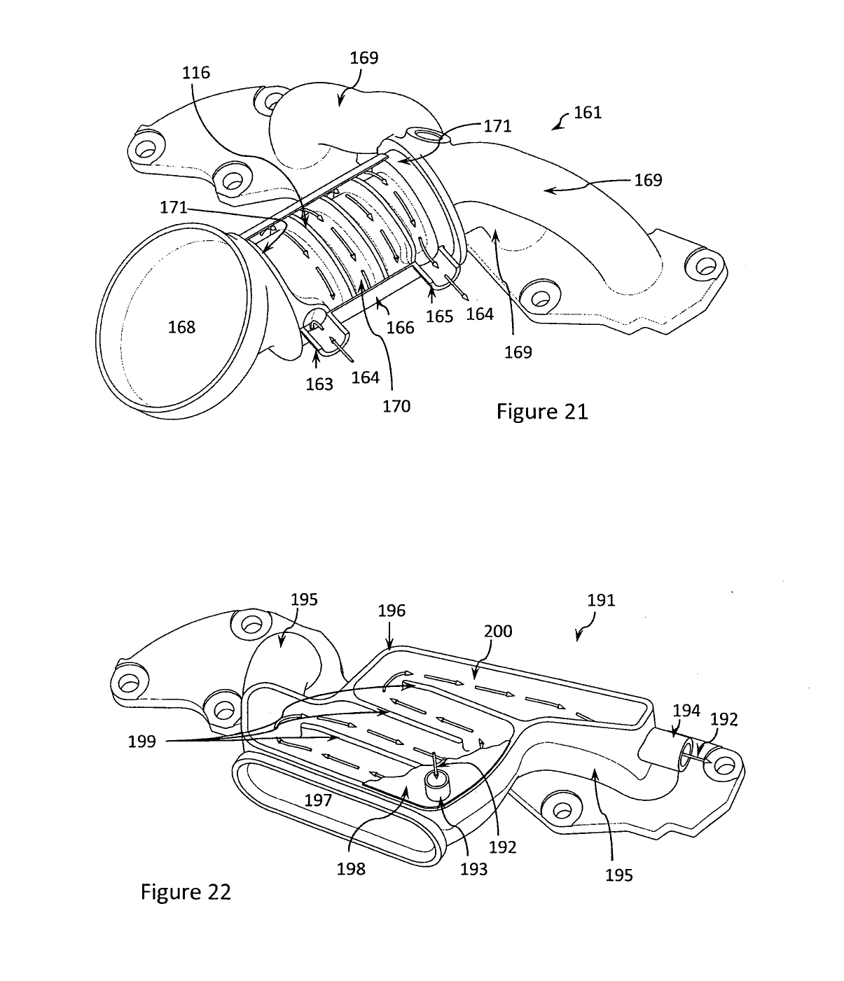

With reference to FIG. 21, a cast exhaust manifold or other exhaust component 161 is provided that may include exhaust manifold runners 169 that contain and convey the exhaust gases to an outlet 168 of the exhaust component 161. The exhaust gas passageway from each manifold runner 169 is brought together to align axially prior to the outlet 168. A helical coolant channel 170 is formed along the external surface of the exhaust component 161 in this region upstream of the outlet 168. The helical channel 170 is formed by a helical rib 167 that is cast as part of the cast exhaust component 161. The helical cooling passageway 170 is closed by a wrought steel tubular sleeve that is forms a cover plate 166. The helical rib 167 is arranged in a fashion to control and direct the flow of cooling fluid 164 from the coolant inlet 163 to coolant outlet 165. The coolant inlet 163 and coolant outlet 165 are joined to the cover plate 166. The tubular cover plate 166 may be joined to the cast exhaust component 161 at interfaces 171 disposed at either end of the tubular cover plate 166.

FIG. 22 is another embodiment of a fluid-cooled cast exhaust manifold 191 designed to extract thermal energy from the exhaust gases to warm up the engine coolant. A cover plate 198 is welded to the exhaust manifold 191 along the weld interface 196. A coolant inlet 193 is joined the cover plate 198 and the coolant outlet 194 is formed integrally with the cast exhaust manifold. Thermal energy is transferred from the exhaust gases to the coolant as the exhaust gases flow through manifold runners 195 before flowing into to an exhaust gas outlet collector 197. An intermediate wall or rib 199 is formed as part of the casting for the purposes of guiding and distributing a flow of coolant 192 through the coolant passageway 200. The relatively cooler surface provided by the cover plate 98 may reduce or eliminate any need for heat shielding the exhaust component 191. Geometric irregularities, such as scallops, fins and/or ribs, for example, may be formed in the exhaust gas passageway 200 to enhance heat transfer from the exhaust gases to the coolant.

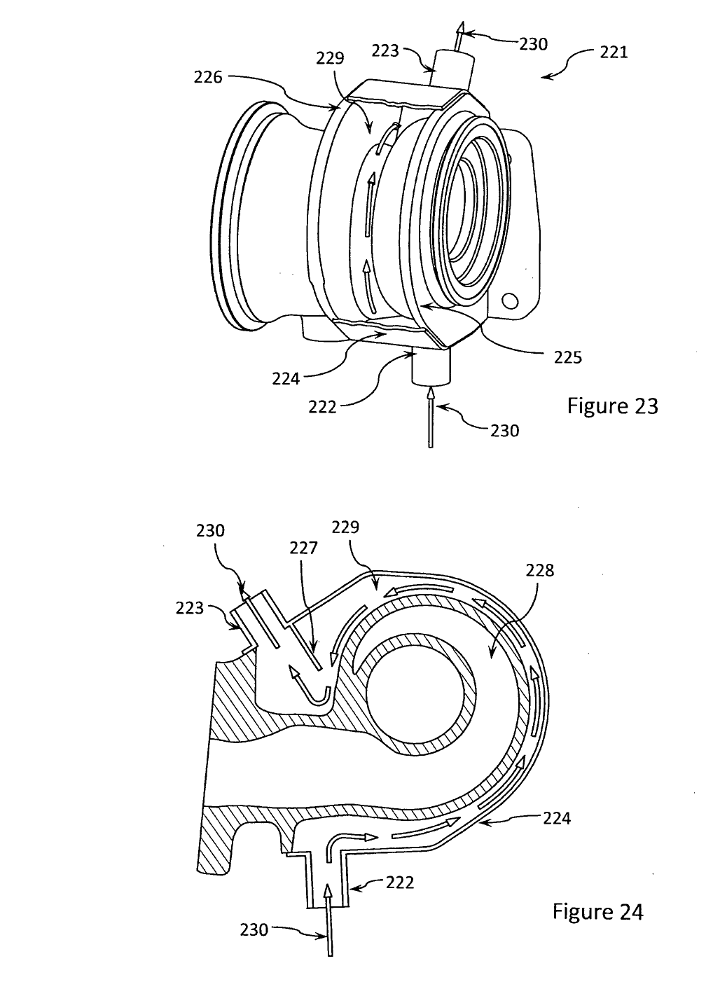

With reference to FIGS. 23 and 24 a turbocharger housing 121 is provided and may include a pair of radially projecting walls 225 and 226 formed more or less on either side of the turbocharger volute 228, which may be the hottest portion of the turbocharger housing due to relatively the high velocity of gas flowing therethrough. Coolant flow 230 from the engine cooling system follows a coolant passageway 229 that may be defined by the walls 225 and 226 and a cover plate 224. The coolant inlet tube 222 and coolant outlet tube 223 are attached to the cover plate 224. A coolant deflector plate 227 attached to the cover plate 224 may direct the flow of coolant 230 along the hot surface of the turbocharger housing and keep the local housing temperature relatively cool.

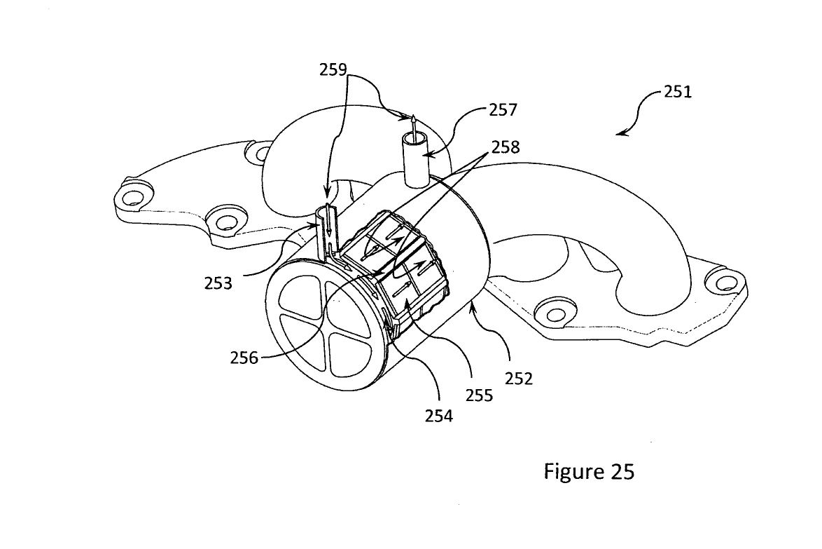

With reference to FIG. 25, an exhaust component 251 is provided an may include one or more thermoelectric devices 255. The thermoelectric devices 255 operate by using the temperature difference created between a hot wall of the exhaust component 251 and a relatively lower temperature in a cooling passageways 258. The exhaust component 251 may include a cylindrical cover plate 252 having a coolant inlet 253 and a coolant outlet 257. A coolant flow path 259 may be arranged such that the coolant entering the exhaust component 251 through inlet 253 flows through a circumferential coolant header 254 and may be distributed through a series of parallel passages 258. The passages 258 may be separated by cast rib features 256. The coolant from the channels is collected in a similar circumferential coolant header (not shown) and exits the exhaust component 251 through the coolant outlet 257.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An exhaust system comprising:
an exhaust component including at least one exhaust gas passageway and partially defining at least one fluid cavity;
at least one plate attached to said exhaust component and at least partially enclosing said at least one fluid cavity to define at least one fluid passageway, said at least one fluid passageway being fluidly isolated from said at least one exhaust gas passageway;
at least one inlet through which a fluid enters said at least one fluid passageway; and
at least one outlet through which said fluid exits said at least one fluid passageway.

2. The exhaust system of claim 1, wherein said exhaust component is one of an exhaust manifold or a turbocharger housing.

3. The exhaust system of claim 1, wherein said fluid cavity is integrally formed with said exhaust component.

4. The exhaust system of claim 3, wherein said at least one plate is welded to said exhaust component.

5. The exhaust system of claim 1, wherein said fluid includes at least one of water, engine coolant, and refrigerant.

6. The exhaust system of claim 1, wherein said fluid absorbs heat from an exhaust gas flowing through said at least one exhaust gas passageway.

7. The exhaust system of claim 1, further comprising a thermoelectric device in heat transfer relation with said exhaust component.

8. An exhaust system for a vehicle comprising:
an exhaust component including an integrally formed exhaust gas passageway and an integrally formed fluid cavity; and
a plate attached to said exhaust component and at least partially enclosing said fluid cavity to define a fluid conduit, said fluid conduit being fluidly isolated from said exhaust gas passageway, said plate including an integrally formed inlet and an integrally formed outlet, said inlet and outlet being in fluid communication with said fluid conduit.

9. The exhaust system of claim 8, wherein said exhaust component is one of an exhaust manifold or a turbocharger housing.

10. The exhaust system of claim 8, wherein said plate is welded to said exhaust component.

11. The exhaust system of claim 8, wherein said fluid includes at least one of water, engine coolant, and refrigerant.

12. The exhaust system of claim 8, wherein said fluid absorbs heat from an exhaust gas flowing through said exhaust gas passageway.

13. The exhaust system of claim 8, further comprising a thermoelectric device in heat transfer relation with said exhaust component.

14. The exhaust system of claim 8, wherein said exhaust component is formed from cast iron and said plate is formed from stainless steel.

15. A method comprising:
casting an exhaust component to include an exhaust gas passageway having an external surface defining a fluid cavity;
providing a plate including a first port and a second port; and
attaching said plate to said exhaust component such that said plate and said fluid cavity cooperate to form a fluid conduit in fluid communication with said first port and said second port.

16. The method of claim 15, further comprising:
supplying a fluid to said first port such that said fluid flows through said fluid conduit; and
transferring heat from an exhaust gas flowing through said exhaust gas passageway to said fluid.

17. The method of claim 16, further comprising providing a thermoelectric device in heat transfer relation with said exhaust gas.

18. The method of claim 16, wherein said fluid and said exhaust gas are fluidly isolated from each other.

19. The method of claim 15, wherein attaching said plate to said exhaust component includes welding said plate to a periphery of said fluid cavity.

20. The method of claim 15, wherein said exhaust component includes at least one of an exhaust manifold and a turbocharger housing.
